(19) United States
(12) Patent Application Publication
(10) Pub. No.: US 2003/0179287 A1
(43) Pub. Date: Sep. 25, 2003

(54) System and method for providing pharmaceutical services to a plurality of remote sites from a central site

(76) Inventors: Dejan Kozic, Wadsworth, IL (US); Charles Goodall, Hawthorn Woods, IL (US); Mohsin Ansari, Glenview, IL (US); Mike Simko, Park Ridge, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/104,615

(22) Filed: Mar. 22, 2002

(51) Int. Cl. H04N 7/14

(52) U.S. Cl. 348/14.08; 348/14.01

(57) ABSTRACT

A system and a method for providing pharmaceutical services to a plurality of remote sites from a central site are described herein. The central site includes a central video-conferencing station operable for a pharmacist to perform pharmaceutical services from within the central site. The central video-conferencing station may be, but is not limited to, a work station including at least one of a facsimile machine, a video camera, a monitor, a computer, and a telephone. Further, the central video-conferencing station is selectively coupled to the plurality of remote sites. The plurality of remote sites is remotely located from the central site. Each of the plurality of remote sites includes a remote video-conferencing station, which may be, but is not limited to, a work station including at least one of a facsimile machine, a video camera, a monitor, a computer, and a telephone. The remote video-conferencing station is operable to provide real-time communication between one of a technician and a customer at one of the plurality of remote sites and the pharmacist within the central site.

### FIELD OF THE INVENTION

The invention relates generally to pharmaceutical services and, more particularly to a system and a method for providing pharmaceutical services to a plurality of remote sites from a central site.

### BACKGROUND OF THE INVENTION

Typically in a pharmacy, a pharmacist is available to provide pharmaceutical services such as preparing and dispensing drugs and medicines, consulting customers, etc. In fact, some stores may have a pharmacy with a pharmacist readily available at any time (e.g., 24 hours a day for 365 days a year). However, other pharmacies may not offer such convenience, i.e., the pharmacy is closed. For example, a pharmacist may not need to be on duty at low volume stores and/or during holidays, off-peak hours, etc. As a result, a pharmacist may not be available during a time of need because of cost and feasibility to employ a pharmacist at every store at all times. Further, some people may need to travel a great distance to get pharmaceutical services because a pharmacy is not conveniently located near their homes. That is, a pharmacy may not be available at all in some remote locations, i.e., rural areas. Thus, a need exist to provide pharmaceutical services when and where a pharmacist is not physically available to do so.

Current video-conferencing equipment provides (1) point-to-point video conference, and (2) multi-point video conference. Point-to-point video conference allows two end-points to communicate with each other. Multi-point video conference involves two or more end-points into the same conversation. However, neither point-to-point nor multi-point video conference works particularly well for applications that require a single central user to communicate in a private point-to-point manner while being connected to other end-points at the same time. For example, a pharmacist may need to speak with a customer in private without other customers being able to hear the conversation. Point-to-point conference provides communication between only two end-points at a time, and multi-point conference fails to provide privacy between two end-points. Further, a pharmacist may need to place a customer on hold, and switch over to attend to another customer. However, current video-conferencing equipment does not allow a particular conversation to occur in a point-to-point manner while maintaining a connection with other endpoints and be able to switch between those endpoints as needed.

Therefore, a need exists for a pharmacist to selectively communicate with a plurality remote sites to provide pharmaceutical services from within a central site.

### BRIEF DESCRIPTION OF THE DRAWINGS

FIG. 1 is a block diagram representation of a system for providing pharmaceutical services that may be adapted to operate in accordance with the preferred embodiments of the invention.

FIG. 2 is a block diagram representation of a central site and a plurality of remote sites that may be adapted to operate in accordance with the preferred embodiments of the invention.

FIG. 3 is a block diagram representation of a central site that may be adapted to operate in accordance with the preferred embodiments of the invention.

FIG. 4 is a block diagram representation of one of a plurality of remote sites that may be adapted to operate in accordance with the preferred embodiments of the invention.

FIG. 5 is a flow diagram illustrating a method for providing pharmaceutical services to a plurality of remote sites from a central site in accordance with the preferred embodiments of the invention.

### DETAILED DESCRIPTION OF THE PREFERRED EMBODIMENTS

Preferred embodiments of a system and a method for providing pharmaceutical services from a central site are described. In particular, the system provides pharmaceutical services to a plurality of remote sites (e.g., drug stores, grocery stores, convenience stores, wholesale stores) remotely located from the central site (e.g., a pharmacy operable to provide pharmaceutical services for 24 hours a day). The central site may be, but is not limited to, one of the plurality of remote sites. The central site includes a central video-conferencing station operable for a pharmacist to perform pharmaceutical services from within the central site. That is, the central video-conferencing station is operable for the pharmacist from within the central site to verify prescription information for a technician within one of the plurality of remote sites. Further, the plurality of video-conferencing station is operable for the pharmacist from within the central site to consult a customer within one of the plurality of remote sites from within the central site. The central video-conferencing station within the central site may be, but is not limited to, a work station including at least one of a facsimile machine, a video camera, a monitor, a computer, and a telephone, and a work station operable for video-conferencing, voice-conferencing, and document-viewing. Each of the plurality of remote sites includes a remote video-conferencing station, which may be, but is not limited to, a work station including at least one of a facsimile machine, a video camera, a computer, a monitor, and a telephone. The central video-conferencing station within the central site is selectively coupled to the remote video-conferencing station within the plurality of remote sites. For example, the central video-conferencing station within the central site may be operatively coupled to the remote video-conferencing station within one of the plurality of remote sites via an Internet connection. The remote video-conferencing station is operable to provide real-time communication between a technician at one the plurality of remote sites and the pharmacist within the central site. Further, the remote video-conferencing station is operable to provide real-time communication between a customer at one of the plurality of remote sites and the pharmacist within the central site. Thus, pharmaceutical services are provided at any time to remote locations where, for example, the pharmacy is closed or a pharmacy is not available at all.

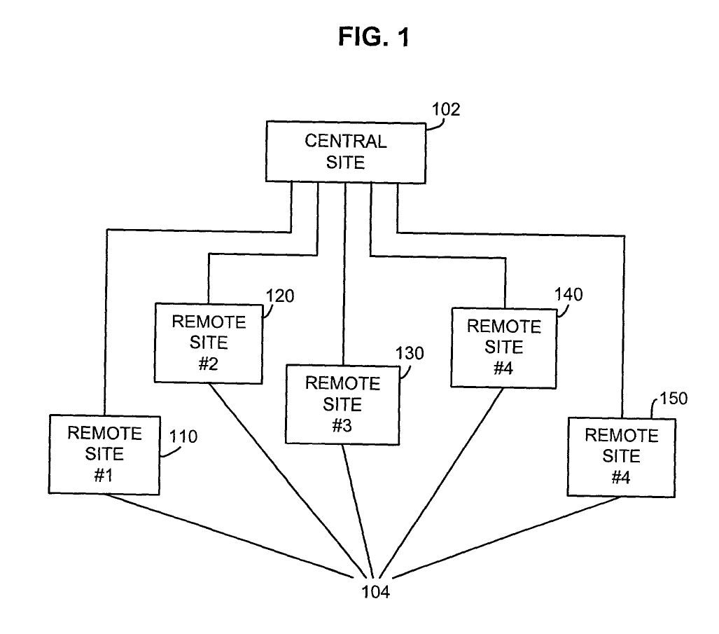

Referring to FIG. 1, a system 100 for providing pharmaceutical services includes a central site 102 and a plurality of remote sites 104, generally shown as Remote Site #1 110, Remote Site #2 120, Remote Site #3 130, Remote Site #4 140 and Remote Site #5 150. The central site 102 may be, but is not limited to, a pharmacy operable to provide pharmaceutical services for 24 hours a day, a site with a plurality of pharmacists, and one of the plurality of remote sites 104. In particular, the central site 102 includes a pharmacist to perform pharmaceutical services such as to verify prescription information and to consult customers within the plurality of remote sites 104 from within the central site 102. The central site 102 is selectively coupled to the plurality of remote sites 104 so that the pharmacist with the central site 102 may place one of the plurality of remote sites 104 on hold while communicating with another one of the plurality of remote sites 104. For example, the pharmacist within the central site 102 may place Remote Site #3 130 on hold to switch over to communicate with Remote Site #1 110. The plurality of remote sites 104 may be, but is not limited to, drug stores, grocery stores, convenience stores, and wholesale stores. Each of the plurality of remote sites 104 is operatively coupled to the central site 102. For example, Remote Site #1 110 may be operatively coupled to the central site 102 via an Internet connection, e.g., a T-1 connection, an Integrated Services Digital Network (ISDN) connection, and Voice over Internet Protocol (VoIP) connection, so that the pharmacist within the central site may communicate with either a technician or a customer at Remote Site #1 110.

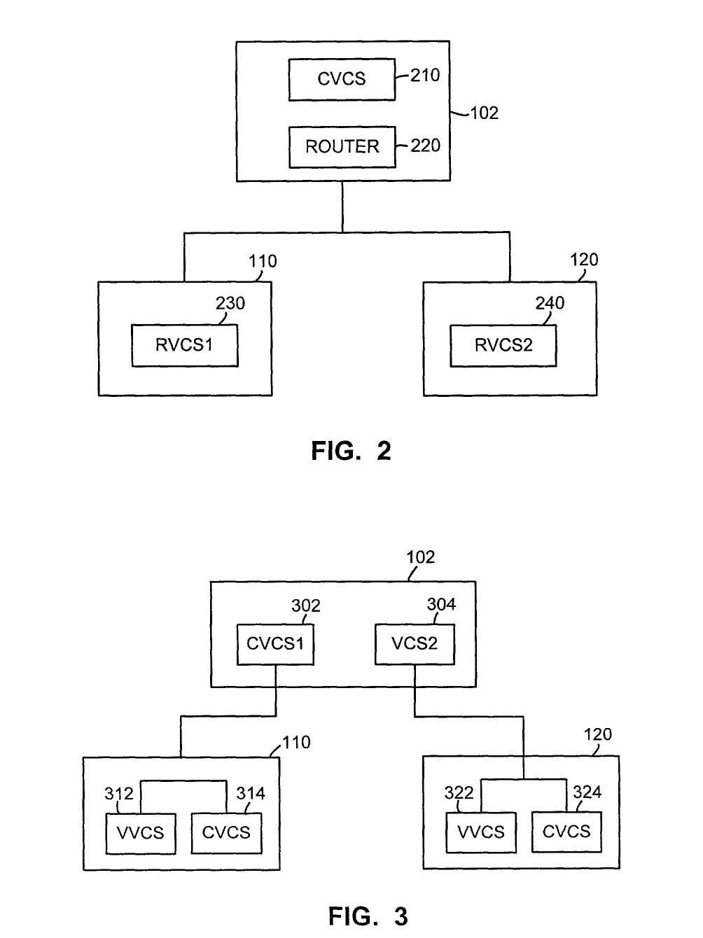

The central site 102 generally includes a central video-conferencing station and a router operatively coupled to the plurality of remote sites 104. Each of the plurality of remote sites 104 includes at least one remote video-conferencing station. The remote video-conferencing station may be located in different areas such as, but not limited to, a pharmacy and a cash register, within one of the plurality of remote sites 104. Referring to FIG. 2, for example, the central site 102 includes a central video-conferencing station 210 (CVCS) and a router 220. The central video-conferencing station 210 is operable for the pharmacist to perform pharmaceutical services from within the central site 102. The router 220 is operatively coupled to remote video-conferencing stations, generally shown as (RVCS1) 230 and (RVCS2) 240, at the pharmacies within Remote Site #1 110 and Remote Site #2 120, respectively. That is, the central video-conferencing station 210 is selectively coupled to the remote video-conferencing stations 230, 240 via the router 220. For example, the remote video-conferencing station 240 within Remote Site #1 110 may be in communication with the central video-conferencing station 210 via the router 220 in response an input made by the pharmacist from the central video-conferencing station 210, e.g., the pharmacist pressing a button. As a result, the pharmacist within the central site 102 may use the central video-conferencing station 210 to communicate with a technician and/or a customer using the remote video-conferencing station 230 at the pharmacy within Remote Site #1 110. In another example, the pharmacist within the central site 102 may select to communicate with the technician and/or the customer at the pharmacy within Remote Site #2 120. Thus, the central video-conferencing station 210 may be operatively coupled to the remote video-conferencing station 240 at the pharmacy of Remote Site #2 via the router 220 to provide real-time communication between the pharmacist within the central site 102 and the technician and/or the customer at the pharmacy of Remote Site #2 120. Further, the pharmacist within the central site 102 may place the remote video-conferencing station 210 within Remote Site #1 110 on hold and switch over to communicate with the remote video-conferencing station 240 within Remote Site #2 120. The router 220 may be operatively coupled to additional remote video-conferencing stations so that the pharmacist within the central site 102 may perform pharmaceutical services for other remote sites such as Remote Site #3 130, Remote Site #4 140, and Remote Site #150 as shown in FIG. 1. Accordingly, the central video-conferencing station 210 is selectively coupled to the remote video-conferencing stations within those other remote sites.

In an alternate embodiment, the central site 102 includes a plurality of central video-conferencing stations, and each of the plurality of video-conferencing stations is associated with one of the plurality of remote sites 104. Further, each of the plurality of remote sites 104 includes a verification video-conferencing station and a consultation video-conferencing station to provide real-time communication with the pharmacist within the central site 102. Referring to FIG. 3, the central site 102 includes, for example, a first video-conferencing station (VCS1) 302 and a second video-conferencing station (VCS2) 304. That is, the first video-conferencing station 302 is associated with Remote Site #1 110, and the second video-conferencing station 304 is associated with Remote Site #2 120. The central site 102 may include additional video-conferencing stations so that the pharmacist within the central site 102 may perform pharmaceutical services for other remote sites such as Remote Site #3 130, Remote Site #4 140, and Remote Site #150 as shown in FIG. 1. Referring to FIG. 3 again, each of Remote Site #1 110 and Remote Site #2 120 includes a verification video-conferencing station (VVCS), generally shown as 312 and 322, respectively, and a consultation video-conferencing station (CVCS), generally shown as 314 and 324, respectively. In particular, the first video-conferencing station 302 of the central site 102 is operatively coupled to the verification video-conferencing station 312 and the consultation video-conferencing station 314 of Remote Site #1 110, and the second video-conferencing station 304 of the central site 102 is operatively coupled to the verification video-conferencing station 322 and the consultation video-conferencing station 324 of Remote Site #2 120. For example, the first video-conferencing station 302 of the central site 102 may be operatively coupled to both the verification video-conferencing station 312 and the consultation video-conferencing station 314 of Remote Site #1 110 via an Internet connection such as a T-1 connection, a ISDN connection, and a VoIP connection. Accordingly, the second video-conferencing station 304 of the central site 102 may be operatively coupled to both the verification video-conferencing station 322 and the consultation video-conferencing station 324 of Remote Site #2 120 via an Internet connection.

As noted above, the pharmacist within the central site 102 may provide pharmaceutical services to the plurality of remote sites 104 from within the central site 102. For example, a technician at the pharmacy of Remote Site #1 110 may use the verification video conference station 312 to communicate in real-time with the pharmacist within the central site 102 to verify prescription information. The technician may transmit images associated with one of, but not limited to, a hard copy of a prescription, a prescription label, a dispensed drug based on a prescription, and NDC numbers on a drug package to the first video-conferencing station 302 within the central site 102 for the pharmacist to verify. Further, a customer at the pharmacy of Remote Site #1 110 may use the consultation video conference station 314 to communicate in real-time with the pharmacist within the central site 102 to ask questions about, for example, dosages, generic brand, etc. Using the first video-conferencing station 302, the pharmacist may consult the customer at the pharmacy of Remote Site #1 110 from within the central site 102. Likewise, a technician and a patient at the pharmacy of Remote Site #2 120 may use the verification video conference station 322 and the consultation video conference station 324, respectively, to communicate in real-time with the pharmacist within the central site 102. Thus, the pharmacist may also provide pharmaceutical services to Remote Site #2 120 from within the central site 102.

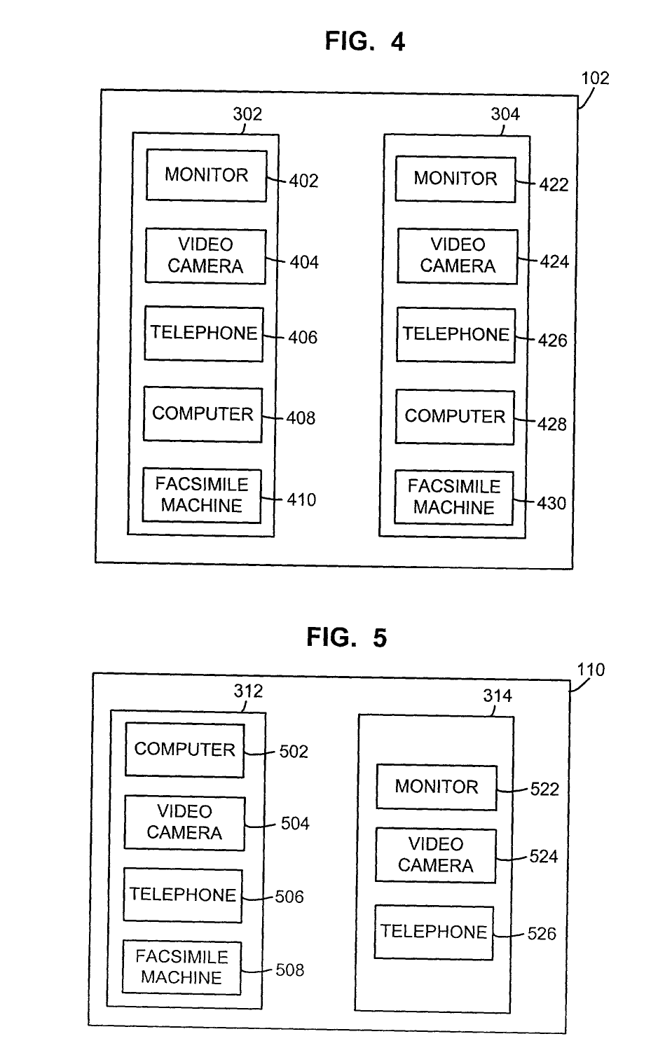

As shown in FIG. 4, the first video-conferencing station 302 of the central site 102 generally includes equipment such as a monitor 402, a video camera 404, a telephone 406, a computer 408, and a facsimile machine 410. The second video-conferencing station 304 also includes a monitor 422, a video camera 424, a telephone 426, a computer 428, and a facsimile machine 430. As noted above, each video-conferencing station within the central site 102 is associated with one of the plurality of remote sites 104, i.e., the first video-conferencing station 302 is associated with Remote Site #1 110, and the second video-conferencing station 304 is associated with Remote Site #2 120. The plurality of video-conferencing stations within the central site 102 is operatively coupled to the plurality of remote sites 104 so that a pharmacist within the central site 102 may switch from one video-conferencing station to another to communicate with technicians and customers at different remote sites. Accordingly, the pharmacist within the central site 102 uses the first video-conferencing station 302 to communicate in real-time with a technician and/or a patient at the pharmacy of Remote Site #1 110, and the pharmacist within the central site 102 uses the second video-conferencing station 304 to communicate with a technician and/or a patient at the pharmacy of Remote Site #2 120. To illustrate this concept, the pharmacist within the central site 102 may use the first video-conferencing station 302 to verify prescription information for a technician from Remote Site #1 110. That is, the pharmacist may use the monitor 402 to view an image of dispensed drugs provided by a technician at the pharmacy of Remote Site #1 110, use the telephone 406 to speak with the technician, and/or use the computer 428 to access a database associated with Remote Site #1 110. In an alternate embodiment, the pharmacist may use a microphone and a speaker that are operatively coupled to the computer 408 to communicate with the technician. The pharmacist within the central site 102 may also use the first video-conferencing station 302 to consult a customer at Remote Site #1 110 as if the pharmacist is consulting the customer in-person. The pharmacist may be able to view the customer via the monitor 402 and to speak with the customer via the telephone 406. Accordingly, the pharmacist within the central site 102 may use the second video-conferencing station 304 to verify prescription information for a technician and to consult a customer at Remote Site #2 120.

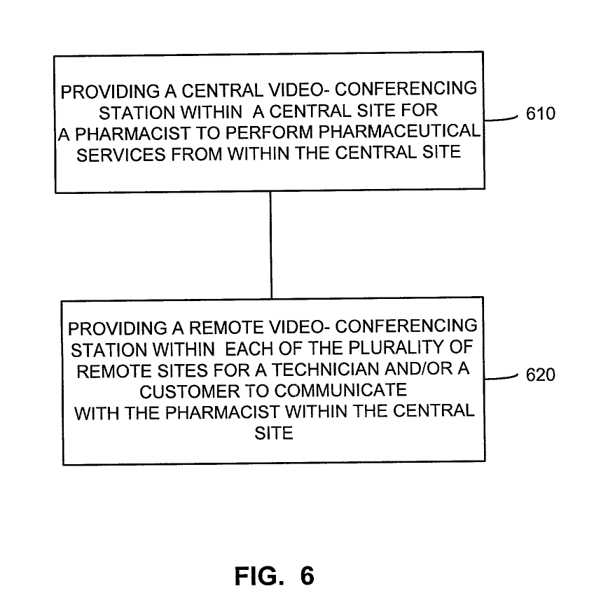

As noted above, each of the plurality of remote sites includes a verification video-conferencing station and a consultation video-conferencing station. Referring to FIG. 5, for example, the verification video-conferencing station 312 of Remote Site #1 110 generally includes a computer 502, a video camera 504, a telephone 506, and a facsimile machine 408, and the consultation video-conferencing station 314 of Remote Site #1 110 generally includes a monitor 522, a video camera 524, and a telephone 526. A technician at Remote Site #1 110 may use the verification video-conferencing station 312 to transmit an image associated with a prescription such as, but not limited to, a hard copy of a prescription, a prescription label, a dispensed drug based on a prescription, and NDC numbers on a drug package, to the first video-conferencing station 302 for the pharmacist within the central site 102 to verify. For example, the technician at Remote Site #1 110 may use the video camera 404 to transmit an image of dispensed drugs based on a prescription to the pharmacist within the central site 102, and use the telephone 506 to speak with the pharmacist to verify the prescription. A customer at Remote Site #1 110 may use the consultation video-conferencing station 314 to communicate in real-time with the pharmacist within the central site 102. That is, the customer at Remote Site #1 110 may use the monitor 522 to see the pharmacist within the central site 102, and use the telephone 526 to speak with and listen to the pharmacist. Thus, the verification video-conferencing station and the consultation video-conferencing station allow the technician and the customer, respectively, to communicate with the pharmacist so that the pharmacist may perform pharmaceutical services from within the central site 102.

In accordance with the preferred embodiments of the present invention, and with references to FIG. 6, a method for providing pharmaceutical services to a plurality of remote sites from a central site is shown, Method 600 begins at step 610, where a central video-conferencing station is provided within the central site. The central video-conferencing station is operable for a pharmacist to perform pharmaceutical services from within the central site. For example, the central video-conferencing station is operable for the pharmacist to verify prescription information for technicians at the plurality of remote sites from within the central site. Further, the central video-conferencing station is operable for the pharmacist to consult customers within the plurality of remote sites from within the central site. The central video-conferencing station is selectively coupled to a remote video-conferencing station at the pharmacy within one of the plurality of remote sites so that the pharmacist within the central site may be able to switch from one remote video-conferencing station to another to communicate with technicians and customers at different remote sites. In an alternate embodiment, the central site includes a plurality of video-conferencing station such that each of the plurality of central video-conferencing stations is associated with one of the plurality of remote sites. That is, each of the plurality of central video-conferencing stations is operatively coupled to the remote video-conferencing station within each of the plurality of remote sites. At step 520, the remote video-conferencing station is provided within each of the plurality of remote sites. The remote video-conferencing station may be operatively coupled to the central video-conferencing stations within the central site via an Internet connection (e.g., a T-1 connection, an ISDN connection, and a VoIP connection) to provide real-time communication between a technician and/or a customer at one of the plurality of remote sites and the pharmacist within the central site. In particular, the remote video-conferencing station includes at least one of, but is not limited to, a facsimile machine, a video camera, a computer, a monitor, and a telephone. For example, the technician may use the verification video-conferencing station to transmit an image associated with the dispensed drugs for the pharmacist to verify. The remote video-conferencing station may be, but is not limited to, a verification video-conferencing station and a consultation video-conferencing station. In particular, a technician may use the verification video-conferencing station to verify prescription information with the pharmacist, and a customer may use the consultation video-conferencing station to consult with pharmacist. Thus, the central video-conferencing station and the remote video-conferencing station allow the pharmacist to perform pharmaceutical services for a plurality of remote sites from within the central site.

Many changes and modifications could be made to the invention without departing from the fair scope and spirit thereof. The scope of some changes is discussed above. The scope of others will become apparent from the appended claims.

What is claimed:

1. A system for providing pharmaceutical services comprising:
a central site having a central video-conferencing station, the central video-conferencing station being operable for a pharmacist to perform pharmaceutical services from within the central site; and
a plurality of remote sites remotely located from the central site, each of the plurality of remote sites includes a remote video-conferencing station operable to provide real-time communication between one of a technician and a customer at the each of the plurality of remote sites and the pharmacist within the central site,
wherein the central video-conferencing station within the central site is selectively coupled to the remote video-conferencing station within one of the plurality of remote sites.

2. The system of claim 1, wherein the central video-conferencing station comprises a video-conferencing station operable for the pharmacist to verify prescription information for a technician at one the plurality of remote sites from within the central site.

3. The system of claim 1, wherein the central video-conferencing station comprises a video-conferencing station operable for the pharmacist to consult a customer at one of the plurality of remote sites from within the central site.

4. The system of claim 1, wherein the central video-conferencing station within the central site comprises at least one of a facsimile machine, a video camera, a monitor, a computer, and a telephone.

5. The system of claim 1, wherein the central video-conferencing station within the central site comprises a work station operable for at least one of video-conferencing, voice-conferencing, and document-viewing.

6. The system of claim 1, wherein the central video-conferencing station within the central site is selectively coupled to the remote video-conferencing station within one of the plurality of remote sites via an Internet connection.

7. The system of claim 1, wherein the central site comprises a first central video-conferencing station and a second central video-conferencing station, wherein the first central video-conferencing station is selectively coupled to the remote video-conferencing station within a first remote site of the plurality of remote sites, and wherein the second central video-conferencing station is selectively coupled to the remote video-conferencing station within a second remote sites of the plurality of remote sites.

8. The system of claim 1, wherein the central site comprises one of the plurality of remote sites.

9. The system of claim 1, wherein the remote site comprises a remote site operable to provide pharmaceutical services for 24 hours a day.

10. The system of claim 1, wherein the remote video-conferencing station within one of the plurality of remote sites comprises at least one of a facsimile machine, a video camera, a computer, a monitor, and a telephone.

11. The system of claim 1, wherein the plurality of remote sites comprises one of a drug store, a grocery store, a convenience store, and a wholesale store.

12. A system for providing pharmaceutical services, wherein a central site is operatively coupled to a plurality of remote sites, the system comprising:
a central video-conferencing station within the central site, the central video-conferencing station being operable for a pharmacist to perform pharmaceutical services from within the central site;
a verification video-conferencing station within each of the plurality of remote sites, the verification video-conferencing station being operable to provide real-time communication between a technician at the each of the plurality of remote sites and the pharmacist within the central site; and
a consultation video-conferencing station within each of the plurality of remote sites, the consultation video-conferencing station being operable to provide real-time communication between a customer at the each of the plurality of remote sites and the pharmacist within the central site,
wherein the central video-conferencing station is selectively coupled to one of the verification video-conferencing station and the consultation video-conferencing station within one of the plurality of remote sites.

13. The system of claim 12, wherein the central video-conferencing station comprises a video-conferencing station operable for the pharmacist to verify prescription information for a technician within one of the plurality of remote sites from within the central site.

14. The system of claim 12, wherein the central video-conferencing station comprises a video-conferencing station operable to receive an image associated with a hard copy of a prescription, a prescription label, a dispensed drug based on a prescription, and NDC numbers on a drug package from the verification video-conferencing station within one of the plurality of remote sites.

15. The system of claim 12, wherein the central video-conferencing stations comprises a video-conferencing station operable for the pharmacist to consult a customer within one of the plurality of remote sites from within the central site.

16. The system of claim 12, wherein the central video-conferencing station within the central site comprises at least one of a facsimile machine, a video camera, a monitor, a computer, and a telephone.

17. The system of claim 12, wherein the central video-conferencing station within the central site comprises a work station operable for at least one of video-conferencing, voice-conferencing, and document-viewing.

18. The system of claim 12, wherein the central video-conferencing station within the central site is selectively coupled to the remote video-conferencing station within one of the plurality of remote sites via an Internet connection.

19. The system of claim 12, wherein the central site comprises a first central video-conferencing station and a second central video-conferencing station, wherein the first central video-conferencing station is selectively coupled to the remote video-conferencing station within a first remote site of the plurality of remote sites, and wherein the second central video-conferencing station is selectively coupled to the remote video-conferencing station within a second remote site of the plurality of remote sites.

20. The system of claim 12, wherein the central site comprises one of the plurality of remote sites.

21. The system of claim 12, wherein the verification video-conferencing station comprises at least one of a facsimile machine, a video camera, a computer, and a telephone.

22. The system of claim 12, wherein the consultation video-conferencing station comprises at least one of a video camera, a monitor, and a telephone.

23. The system of claim 12, wherein the plurality of remote sites comprises a plurality of stores, and wherein each of the plurality of stores comprises a pharmacy.

24. The system of claim 12, wherein the plurality of remote sites comprises one of a drug store, a grocery store, a convenience store, and a wholesale store.

25. In a system for providing pharmaceutical services, wherein a central site includes a central video-conferencing station operable for a pharmacist to perform pharmaceutical services from within the central site for a plurality of pharmacies, wherein the central video-conferencing station is selectively coupled to one of the plurality of pharmacies, and wherein the plurality of pharmacies is remotely located from the central site, each of the plurality of pharmacies comprising:
a verification video-conferencing station operatively coupled to the central video-conferencing station within the central site, the verification video-conferencing station being operable to provide real-time communication between a technician at the each of the plurality of pharmacies and a pharmacist within the central site; and
a consultation video-conferencing station operatively coupled to the central video-conferencing station within the central site, the consultation video-conferencing station being operable to provide real-time communication between a patient within the each of the plurality of pharmacies and a pharmacist within the central site.

26. The each of the plurality of pharmacies of claim 25, wherein the verification video-conferencing station comprises at least one of a facsimile machine video camera, a computer, and a telephone.

27. The each of the plurality of pharmacies of claim 25, wherein the verification video-conferencing station is operatively coupled to the central video-conferencing station within the central site via an Internet connection.

28. The each of the plurality of pharmacies of claim 25, wherein the consultation video-conferencing station comprises at least one of a video camera, a monitor, and a telephone.

29. The each of the plurality of pharmacies of claim 25, wherein the consultation video-conferencing station is operatively coupled to the central video-conferencing station within the central site via an Internet connection.

30. The each of the plurality of pharmacies of claim 25, the each of the plurality of pharmacies comprises a pharmacy within one of a drug store, a grocery store, a convenience store, and a wholesale store.

31. A method for providing pharmaceutical services, wherein a central site is operatively coupled to a plurality of remote sites, the method comprising:
providing a central video-conferencing station within the central site, the central video-conferencing station being operable for a pharmacist to perform pharmaceutical services from within the central site,
providing a remote video-conferencing station within each of the plurality of remote sites, the remote video-conferencing station being operable to provide real-time communication between one of a technician and a customer at the each of the plurality of remote sites and the pharmacist within the central site,
wherein the central video-conferencing station within the central site is selectively coupled to the remote video-conferencing station within one of the plurality of remote sites.

32. The method of claim 31, wherein the step of providing a central video-conferencing station within the central site comprises providing a central video-conferencing stations operable to receive prescription information from the remote video-conferencing station within each of the plurality of remote sites.

33. The method of claim 31, wherein the step of providing a central video-conferencing station comprises providing a central video-conferencing station operable to receive an image associated with a hard copy of a prescription, a prescription label, a dispensed drug based on a prescription, and NDC numbers on a drug package from the remote video-conferencing station within each of the plurality of remote sites.

34. The method of claim 31, wherein the step of providing a central video-conferencing station within the central site comprises providing a central video-conferencing station within one of the plurality of remote sites.

35. The method of claim 31, wherein the step of providing a central video-conferencing station within the central site comprises providing a work station having at one of a facsimile machine, a video camera, a monitor, a computer, and a telephone.

36. The method of claim 31, wherein the step of providing a central video-conferencing station within the central site comprises providing a work station operable for at least one of video-conferencing, voice-conferencing, and document-viewing.

37. The method of claim 31, wherein the step of providing a central video-conferencing station within the central site comprises providing a first central video-conferencing station and a second central video-conferencing station within the central site, wherein the first central video-conferencing station is selectively coupled to the remote video-conferencing station within a first remote site of the plurality of remote sites, and wherein the second central video-conferencing station is selectively coupled to the remote video-conferencing station within a second remote site of the plurality of remote sites.

38. The method of claim 31, wherein the step of providing a central video-conferencing station within the central site comprises providing a central video-conferencing station selectively coupled to the remote video-conferencing station within one of the plurality of remote sites via an Internet connection.

39. The method of claim 31, wherein the step of providing a remote video-conferencing station within each of the plurality of remote sites comprises providing a remote video-conferencing station having at least one of a facsimile machine, a video camera, a computer, a monitor, and a telephone.

40. The method of claim 31, wherein the step of providing a remote video-conferencing station within each of the plurality of remote sites comprises providing a remote video-conferencing station operable to transmit an image associated with a hard copy of a prescription, a prescription label, a dispensed drug based on a prescription, and NDC numbers on a drug package from the remote video-conferencing station within each of the plurality of remote sites.

41. The method of claim 31, wherein the step of providing a remote video-conferencing station within each of the plurality of remote sites comprises providing a remote video-conferencing station within a store having a pharmacy, and wherein the store comprises one of a drug store, a grocery store, a convenience store, and a wholesale store.

42. The method of claim 31, wherein the step of providing a remote video-conferencing station within each of the plurality of remote sites comprises providing one of a verification video-conferencing station and a consultation video-conferencing station within each of the plurality of remote sites.
